(19) United States
(12) Patent Application Publication
(10) Pub. No.: US 2022/0403690 A1
(43) Pub. Date: Dec. 22, 2022

(54) METHOD FOR DETERMINING AND/OR VERIFYING A STATUS OF A DOOR SYSTEM, STATUS DETERMINATION DEVICE, SYSTEM, COMPUTER PROGRAM PRODUCT

(71) Applicant: dormakaba Deutschland GmbH, Ennepetal (DE)

(72) Inventors: Martin WAGNER, Ennepetal (DE); Ingo HALDER, Ennepetal (DE); Benjamin FRIEDRICH, Ennepetal (DE)

(21) Appl. No.: 17/839,907

(22) Filed: Jun. 14, 2022

(30) Foreign Application Priority Data
Jun. 18, 2021 (EP) 21180282.2

(51) Int. Cl. E05F 15/00; G05B 13/02

(52) U.S. Cl. CPC E05F 15/00; G05B 13/0265; E05Y 2400/40; E05Y 2400/502; E05Y 2400/44; E05Y 2800/43; E05Y 2900/132

(57) ABSTRACT

A method for determining and/or verifying a status of a door system includes the following steps:
determining at least one item of measurement information relating to the door system in a measuring step, and
determining and/or verifying the status of the door system using an artificial intelligence system and using the at least one determined item of measurement information in a status determination step.

### CROSS-REFERENCE TO RELATED APPLICATIONS

This application is related to and claims the benefit of European Patent Application No. 21180282.2, filed on Jun. 18, 2021, the contents of which are herein incorporated by reference in their entirety.

### TECHNICAL FIELD

The disclosure relates to a method for determining and/or verifying a status of a door system. The disclosure further relates to a status determination device for determining and/or verifying a status of a door system and to such a system and a computer program product.

### BACKGROUND

Door devices and their partial systems or door systems typically suffer from signs of wear during operation which can be caused by the use of the door device, by the aging of the parts and components or by environmental influences. Such signs of wear can thereby depend on a number of influences and manifest themselves very differently and at different speed. Different door systems of a door device can generally be affected by signs of wear, for example a drive unit of the door device or an electric lock. It is therefore fundamentally necessary to maintain door devices in order to determine and fix signs of wear and defects.

In the case of systems and methods known from the state of the art, maintenance is usually carried out at fixed time intervals, for example once annually, or on the basis of predefined maintenance schedules. According to the state of the art, this, on the one hand, leads to unnecessary maintenance work on door devices. On the other hand, signs of wear are often only identified when they have already led to faults or disruptions in the door device, which entails undesired downtime of the door device.

Maintenance is thereby often time-consuming since specialist personnel have to travel to examine or repair the door device.

Against this background, the object is to enable an efficient determination and/or verification of a status of a door system such that the effort and the costs for maintenance work and/or the downtimes can preferably be reduced.

### SUMMARY

The disclosure provides a method for determining and/or verifying a status of a door system, wherein the method comprises the following steps:
at least one item of measurement information relating to the door system is determined in a measuring step,
the status of the door system is determined and/or verified by means of an artificial intelligence system and by means of the at least one determined item of measurement information in a status determination step.

According to the disclosure, an advantageous status monitoring can be hereby achieved which enables improved planning for maintenance work. According to the disclosure, it is in particular therefore possible to achieve efficient, predictive maintenance for a door system. Therefore, it is in particular possible to determine by means of the artificial intelligence system whether there is wear of the door system and/or of a subsystem of the door system and/or to what extent the wear has progressed. Therefore, time-optimized and individual maintenance can be achieved. In particular, it is possible to select a time for the next maintenance as a function of the determined status of the door system. Additionally or alternatively, it is possible that the maintenance is focused or limited to one subsystem or a plurality of subsystems of the door system, for which wear has been determined when determining and/or verifying the status of the door system by means of the artificial intelligence system. In particular, such a subsystem can comprise a part or an assembly, such as a gear unit and/or a motor and/or an electronic controller.

The term, gear unit, describes an assembly which changes a movement of the motor to a movement of another part, in particular an output. The transmission ratio can thereby be any desired, in particular even 1:1.

According to the disclosure, particularly efficient maintenance can therefore be made possible. In particular, unnecessary maintenance work by a specialist can be reduced or avoided. Both resources and costs can therefore be saved.

It may be advantageous that one, a plurality of, or all the steps of the method are repeated, in particular at regular or irregular intervals or that one, a plurality of, or all the steps of the method are carried out continuously. In this way, a determination and/or verification of a status of a door system can be achieved for a selectable time period. It is conceivable that the steps of the method are carried out in different sequences. It is conceivable that the steps of the method differ in time.

It is conceivable that the status determination step for determining and/or verifying the status of the door system comprises an analysis of the at least one item of measurement information by means of the artificial intelligence system.

The method according to the disclosure is in particular a computer-implemented method, in which one, a plurality of, or all the steps of the method are carried out by computer.

Advantageous further developments and configurations of the present disclosure can be inferred from the dependent claims.

According to one embodiment of the present disclosure, it is provided that the at least one item of measurement information is determined by means of measuring a measurement variable of the door system with a measuring device and/or that the at least one item of measurement information is determined by setting and/or determining an actuation variable of the door system with a control device. The actuation variable can also be understood as a settable variable for the door system, which is output and/or set for example during the operation of the door system by the control device and by means of which the door system is controlled. For the case where the door system is a drive unit of the door device, the actuation variable can for example be a drive voltage and/or one or a plurality of parameters of a pulse width modulation. The measurement variable can also be understood as a measurable variable of the door system.

According to one embodiment of the present disclosure, it is provided that the artificial intelligence system is trained by means of training data, in particular at least partially in a training phase before the status determination step. It is conceivable that the training phase is carried out in full before the status determination step. It is alternatively conceivable that even during the operation of the door system, for example before, during and/or after a status determination step, training data is used to further train the artificial intelligence system. Therefore, it is also possible to adjust and/or optimize the artificial intelligence system while the door system is already in operation and/or while the status of the door system is already being determined and/or verified.

According to one embodiment of the present disclosure, it is provided that the training data comprises at least one item of model information, in particular a model curve, determined and/or output by means of a model. In this way, it is particularly advantageously possible to reduce the necessary amounts of training data, which are obtained by means of measurements and/or test procedures on real door systems and door devices. Door systems and door devices are often individually adjusted to determined application conditions such that identical door devices and/or door systems are produced in many cases at best in very small unit numbers. The training of an artificial intelligence system by means of training data, which has been obtained by measuring and/or testing real door systems and/or door devices, is therefore often very cumbersome and costly, since a variety of data of structurally-identical or very similar door devices must typically be recorded for this purpose. Since the training data comprises model information, which has been generated by means of a model, in particular a simulation model, the test effort for real door systems to train the artificial intelligence system can therefore particularly advantageously be reduced. Therefore, it is possible to advantageously use an artificial intelligence system also for door devices and door systems which are made individually or are adjusted to their application or which are manufactured only in rather small unit numbers.

It is particularly advantageously conceivable that the artificial intelligence system is configured after the training phase in such manner that signs of wear that occur, i.e. in particular anomalies and/or defects, of the door system and/or of a subsystem of the door system can be identified in the measurement information by the artificial intelligence system. In this way, it is in particular possible that signs of wear are reliably identified by means of pattern detection carried out by the artificial intelligence system relating to the measurement information determined during the operation of the door system.

According to one embodiment of the present disclosure, the model can in particular be a simulation model. According to one embodiment of the present disclosure, it is preferably possible that the model is a simulation model of the door system and/or of the door device, which includes the door system.

According to one embodiment of the present disclosure, it is provided that the at least one item of measurement information relates to at least one measurement variable and/or actuation variable of the door system.

According to one embodiment of the present disclosure, it is conceivable that the model has a first model block for a first subsystem of the door system and a second model block for a second subsystem of the door system. The first model block relates in particular to at least one property of the first subsystem and the second model block relates in particular to at least one property of the second subsystem. The properties of the subsystem can in particular thereby be production tolerances, dimensional deviations, part weight and/or effects of wear. Preferably, the model has further model blocks for further subsystems of the door system. In this way, an advantageous assignment of signs of wear, which are identifiable in the measurement information and/or training data relating to the door system, can take place to one of the subsystems, in particular to the first or second subsystem. Therefore, it is possible that the artificial intelligence system is trained by means of the training data, in particular by means of the model information, to determine from the at least one item of measurement information, in particular in the status determination step, for which of the subsystems of the door system there is wear and/or the extent to which the wear has progressed. Therefore, time-optimized and individual maintenance can be achieved. In particular, it is possible to select a time for the next maintenance as a function of the determined status of the door system. In this case, the operating behavior from the past, which can be stored in a storage medium of the door system, in particular operating cycles per time, can also be taken into account. In the case of operating behavior from the past, an average value of the last week, of the last month and/or of the last months can in particular be used.

According to one embodiment of the present disclosure, it is provided that the model is configured in such manner that from a change of one of the properties of the first subsystem and/or of a value of one of the properties of the first subsystem in the first model block, a change of the model and/or a change of the at least one item of model information follows. It is in particular possible to carry out targeted variations of the properties of the model blocks and to identify the effect on the model information, in particular a model curve, obtained by means of the model. This advantageously serves to enable a reliable assignment between signs of wear of the individual subsystems of the door system and the model information, which can be compared with the reality. It is conceivable that a partial region of the operating phase of the door system and/or of the door device is identified and/or determined, which is targetedly monitored and/or measured with a status determination device and/or measuring device and/or control device.

According to one embodiment of the present disclosure, it is provided that a dependency of the at least one item of measurement information on at least one property of the first subsystem is determined and/or quantified by means of the model and/or that a dependency of the at least one item of measurement information on a variation of at least one property of the first subsystem is determined and/or quantified by means of the model.

Therefore, it is in particular conceivable that the dependency of a measurement variable and/or actuation variable of the door system on at least one property of the first subsystem is simulated by means of the model and/or wherein the dependency of a measurement variable and/or actuation variable of the door system on a variation of at least one property of the first subsystem is simulated by means of the model. The same is conceivable for the further subsystems or further model blocks. For example, it is possible that a dependency of the at least one item of measurement information on at least one property of the second subsystem is determined and/or quantified by means of the model and/or

that a dependency of the at least one item of measurement information on a variation of at least one property of the second subsystem is determined and/or quantified by means of the model.

According to one embodiment of the present disclosure, it is advantageously conceivable that, for a plurality of, in particular for each subsystem of the door system present in reality, a model block is defined, to which a determined behavior can be designated and/or one or a plurality of physical properties can be added, for example production tolerances, dimensional deviations and/or effects of wear. The model for the door system is preferably composed of the individual subsystems or model blocks, in relation to the subsystems, and provides characteristic model information as a whole. Accordingly, each physical property of a model block is particularly advantageously reflected in the characteristic model information. It is in particular possible that the action of each individual model block can be separately indicated and/or learned through targeted variation. It is possible that the characteristic model information generated by the model, in particular a model curve, can be compared with real measurement curves, which are obtained for example by means of a measuring device and/or a control device. In this way, a particularly advantageous determination and/or verification of a status of the door system is possible, wherein signs of wear of the individual subsystems of the door system can be advantageously discerned and/or identified. Therefore, it can be determined for which of the subsystems of the door system wear is present and/or the extent to which the wear has progressed. In this way, advantageous maintenance can be carried out as a function of the determination and/or verification of the status.

According to one embodiment of the present disclosure, it is advantageously conceivable that the model takes into account and/or comprises the kinematics and/or the kinetics of the door device, of the door system and/or of the subsystems of the door system. It is preferably conceivable that the model takes into account and/or comprises mechanical interactions, mass inertia and/or mechanical forces. It is particularly advantageously conceivable that the model, alternatively or additionally, takes into account and/or comprises electrical interactions, temperatures and/or pressures.

According to one embodiment of the present disclosure, it is provided that the model is verified and/or tested by means of one or a plurality of measurement values and/or actuation values relating to the door system and/or relating to a further door system in a testing step of the model, preferably before the status determination step, wherein it is in particular verified during the verification and/or during the test whether the model meets an accuracy criterion. It is thereby in particular verified whether the model information (or simulation data) of the model achieves a desired accuracy compared to the one or the plurality of measurement values and/or actuation values, which are determined in particular by means of real measurements and/or real settings on a physical or real door system. The testing step can take place before and/or during the ongoing operation of the door system and/or of the door device.

According to one preferred embodiment of the present disclosure, it is conceivable that when the model meets the accuracy criterion, i.e. a desired accuracy is achieved, the model is preferably used in the status determination step for determining and/or verifying the status of the door system or used for generating model information for training the artificial intelligence system. If the model does not meet the accuracy criterion, i.e. a desired accuracy is not achieved, the model is preferably adjusted and/or changed, in particular until it meets the accuracy criterion. The model is particularly preferably used only after meeting the accuracy criterion in the status determination step for determining and/or verifying the status of the door system or for generating model information for training the artificial intelligence system. The accuracy criterion is in particular a selectable and/or predefinable criterion.

According to one embodiment of the present disclosure, it is possible, in particular for a door system with a gear unit including a drive unit, that the model has a model block for the gear unit. The gear unit is usually mechanically and kinematically complex such that model information for the training data is helpful in this case.

According to one embodiment of the present disclosure, it is possible, in particular for a door system with a tab carriage including a drive unit, that the model has a model block for the tab carriage. The tab carriage is in particular used in hinged door drives to change, indirectly or directly, a linear movement, in particular of a spring, into a rotational movement. The tab carriage can thereby comprise a bearing, in particular a needle bearing. Such a bearing generally represents the most highly-loaded part of the door system. Therefore, the tab carriage is suitable both as a model block and as a subsystem, in particular wherein signs of wear thereof are discernible via the motor current and/or via PWM and/or via acoustics, in particular structure-borne sound.

According to one embodiment of the present disclosure, it is possible, in particular for a door system including a drive unit, that the model has a model block for a door or a door leaf.

According to one embodiment of the present disclosure, it is possible, in particular fora door system with a motor including a drive unit, that the model has a model block for the motor. In the case of the motor, electric and mechanical factors encounter one another such that model information for the training data is helpful in this case.

According to one embodiment of the present disclosure, it is possible, in particular for a door system with an electronic control device including a drive unit, that the model has a model block for the electronic control device. The control device ensures a closed control circuit and therefore is also suitable as a subsystem, in particular wherein signs of wear thereof are discernible from electric measurement variables, such as voltage and/or current and/or PWM.

According to one embodiment of the present disclosure, it is possible, in particular for a door system with a deflection unit including a drive unit, that the model has a model block for the deflection unit, in particular a deflection roller and/or a toothed belt. The deflection unit is generally prone to wear, in particular due to the numerous direction changes of the movements. The deflection unit is therefore also suitable as a subsystem, in particular wherein signs of wear thereof are discernible from measurement information relating to acoustics, in particular structure-borne sound, the current profile and/or PWM.

According to one embodiment of the present disclosure, it is possible, in particular for a door system including a drive unit, that the model has a model block for an energy accumulator, in particular a spring or a battery.

According to one embodiment of the present disclosure, it is possible, in particular for a door system with a power supply including a drive unit, that the model has a model block for the power supply. The power supply can comprise capacitors, which can wear after a certain length of time and fail in the case of high electrical load. Therefore, the power supply is also suitable as a subsystem, in particular wherein signs of wear thereof are discernible from measurement information relating to the voltage.

According to one embodiment of the present disclosure, it is possible, in particular for a door system including a drive unit, that the model has a model block for a force transmission element, for example a toothed belt. Such an element is in particular used for sliding doors and is subject to fabric abrasion. Signs of wear are thereby advantageously discernible from measurement information relating to acoustics, in particular structure-borne sound, position profile and/or current profile.

According to one exemplary embodiment of the present disclosure, it is conceivable that the model for a door system, which includes a drive unit of a door device, comprises one, a plurality of or all of the following model blocks:
a first model block, relating to a gear unit,
a second model block, relating to a tab carriage,
a third model block, relating to a door,
a fourth model block, relating to a motor,
a fifth model block, relating to an electronic controller,
a sixth model block, relating to a deflection unit, in particular a deflection roller and/or a toothed belt.
a seventh model block, relating to an energy accumulator, in particular a spring,
an eighth model block, relating to a power supply,
a ninth model block, relating to a force transmission element, for example a toothed belt.

According to one embodiment of the present disclosure, it is conceivable that the training data comprises training measurement information relating to the door system and/or relating to a door device comprising the door system and/or that the training data comprises training measurement information relating to a further door system and/or a further door device comprising the further door system. The training measurement information is determined in particular by measuring one or a plurality of measurement variable by means of corresponding measuring devices at the door system and/or the door device and/or at one or a plurality of further door systems and/or one or a plurality of further door devices. Additionally or alternatively, the training measurement information is determined in particular by determining one or a plurality of actuation variables by means of corresponding control devices at the door system and/or the door device and/or at one or a plurality of further door systems and/or one or a plurality of further door devices. It is conceivable that the training measurement information is determined partially or completely in a separate test phase of the door system and/or of the door device and/or of the one or of the plurality of further door systems and/or of the one or of the plurality of further door devices. It is conceivable that the training measurement information is determined partially or completely during operation or in use, in particular during a status determination of the door system and/or of the door device and/or of the one or of the plurality of further door systems and/or of the one or of the plurality of further door devices.

According to one embodiment of the present disclosure, it is in particular conceivable that the training data comprises both model information and training measurement information.

According to one embodiment of the present disclosure, it is provided that the training data includes normal operation data, in particular wherein the normal operation data relates to a wear-free state of the door system

and
that the training data includes wear operation data, in particular wherein the wear operation data relates to a wear state of the door system and/or a wear state of a subsystem of the door system. It is particularly advantageously possible that the artificial intelligence system for detecting signs of wear of one or of a plurality of subsystems of the door system is trained in the at least one item of measurement information. Therefore, it is possible that the artificial intelligence system, in particular in the status determination step, assigns a sign of wear determined in the at least one item of measurement information to a determined subsystem of the door system. Therefore, the determination of the status of the door system, in particular in the status determination step, can preferably comprise the wear status of one or of a plurality of subsystems of the door system being determined and/or output. The normal operation data is in particular model information and/or training measurement information. It is particularly preferable for the normal operation data to comprise at least model information. The wear operation data is in particular model information and/or training measurement information. It is particularly preferable for the wear operation data to comprise at least model information.

According to one embodiment of the present disclosure, it is provided
that a partial region of an operating phase of the door system is determined by means of the artificial intelligence system, in which a sign of wear of a subsystem of the door system and/or a sign of wear of the door system is determinable by means of determining the at least one item of measurement information, in particular by means of determining at least one measurement variable and/or actuation variable; and/or
that a partial region of an operating phase of the door system is determined by means of a model, in which a sign of wear of a subsystem of the door system and/or a sign of wear of the door system is determinable by means of determining the at least one item of measurement information, in particular by means of determining at least one measurement variable and/or actuation variable. This can be understood in such manner that the model and/or the artificial intelligence system generates partial region information, which indicates a partial region of an operating phase of the door system suitable for determining a sign of wear of a determined subsystem of the door system by monitoring a measurement variable and/or actuation variable of the door system in this partial region. Therefore, a partial region of an operating phase of the door system can preferably be determined, whose monitoring during the operation of the door system is particularly advantageous since signs of wear of the door system in this partial region can become noticeable in a measurement variable and/or actuation variable of the door system. The partial region can thereby comprise an associated region or two or more separate and spaced apart regions of the operating phase.

According to one embodiment of the present disclosure, it is provided that the operating phase of the door system comprises an opening process and/or a closing process of the door system and/or of a door device including the door system, wherein the partial region of the operating phase is only a partial region of the opening process and/or of the closing process. The opening process can also be understood as opening travel. The closing process can also be understood as closing travel. In the case of a revolving door and/or a rotatable separation device, a full rotation of the door element or of the separation device can for example be understood as a complete opening and closing process.

According to one embodiment of the present disclosure, it is provided the at least one item of measurement information used in the status determination step to determine and/or verify the status of the door system relates only to the partial region of the operating phase of the door system. According to one embodiment of the present disclosure, it is possible that the measurement information is formed by a numeric integration of measurement values determined in the partial region relating to at least one measurement variable and/or actuation values relating to at least one actuation variable.

According to one embodiment of the present disclosure, it is provided that the at least one item of measurement information is determined only during the partial region of the operating phase of the door system and/or of the door device. The measurement information is therefore preferably determined in such manner that the measurement variable of the door system is measured by the measuring device for generating the at least one item of measurement information only in the partial region. Alternatively or additionally, the measurement information is therefore preferably determined in such manner that the actuation variable of the door system is measured by the control device for generating the at least one item of measurement information only in the partial region. In particular, it is hereby conceivable that the measurement information is not determined during at least one further partial region of the operating phase or that the measurement information is not determined during the entire operating phase outside of the partial region. In this way, costs and energy can be saved and the amount of data generated can be kept low.

According to one embodiment of the present disclosure, it is provided that a further item of measurement information, in particular relating to the same measurement variable and/or actuation variable as the measurement information, is determined during a further partial region of the operating phase of the door system,

wherein the determination and/or verification of the status of the door system, in particular in the status determination step, is independent of the further measurement information and/or wherein the further measurement information remains disregarded when determining and/or verifying the status of the door system, in particular in the status determination step. Therefore, it is conceivable that the further measurement information does not influence the determination and/or monitoring of the status of the door system. Therefore, it is conceivable that the measurement information relating to the measurement variable and/or actuation variable is determined during the entire operating phase of the door system, in particular by a measurement variable being determined and/or an actuation variable being set and/or determined during the entire operating phase of the door system, wherein only the part of the measurement information determined during the partial region of the operating phase, i.e. in particular the at least one item of measurement information, is used to determine and/or monitor the status of the door system. Measurement information determined outside of the relevant partial region can therefore particularly advantageously remain disregarded during the status determination.

According to one embodiment of the present disclosure, it is provided that the partial region comprises one or a plurality of the following regions:
an acceleration region and/or a braking region, in particular during an opening process and/or a closing process of a door device including the door system,
a constant travel of the door device including the door system, wherein the door device preferably has an at least approximately constant speed during the constant travel,
a starting region of the door device including the door system, in particular from a stand,
a transition region between an acceleration region and a constant travel,
a transition region between an acceleration region and a braking region,
a transition region between a constant travel and a braking region.

According to one embodiment of the present disclosure, it is possible that the partial region comprises at least one acceleration region and/or a braking region, in particular during an opening process and/or a closing process of a door device including the door system.

According to one embodiment of the present disclosure, it is possible that the partial region comprises at least one constant travel of the door device including the door system, wherein the door device preferably has an at least approximately constant speed during the constant travel.

According to one embodiment of the present disclosure, it is possible that the partial region comprises at least one start region of the door device including the door system, in particular from a stand.

According to one embodiment of the present disclosure, it is possible that the partial region comprises at least one transition region between an acceleration region and a constant travel.

According to one embodiment of the present disclosure, it is possible that the partial region comprises at least one transition region between an acceleration region and a braking region.

According to one embodiment of the present disclosure, it is possible that the partial region comprises at least one transition region between a constant travel and a braking region.

According to one embodiment of the present disclosure, it is provided that the partial region comprises one or a plurality of the regions, in which an acceleration and/or an indication of an acceleration and/or a movement direction of the door device and/or of the door system changes. It is for example particularly advantageously possible for a door system formed as a drive unit of a door device that wear of the drive unit or of a subsystem of the drive unit, for example of a gear unit, is discernible in one or a plurality of partial regions, in which the acceleration and/or the indication of the acceleration and/or the movement direction of the door device changes. This includes in particular an acceleration region and/or a braking region and/or a starting region and/or a transition region between an acceleration region and a constant travel and/or a transition region between an acceleration region and a braking region and/or a transition region between a constant travel and a braking region. In particular, wear is particularly advantageously discernible in such partial regions in which mass inertia forces act. It is thereby particularly preferably conceivable that the determined at least one item of measurement information relates to structure-borne sound, speed of a moving part of the motor and/or of the gear unit, in particular an angular speed of the motor, in particular of a rotor, and/or gear unit, in particular of a gear wheel, and/or a current and/or a control voltage of the motor of the drive unit. On the basis of such measurement information, a particularly advantageous determination of signs of wear is thereby possible.

A motor can usually comprise a non-moving part in the form of a stator and the moving part, in particular when designed as a rotary motor in the form of a rotor.

According to one embodiment of the present disclosure, it is advantageously conceivable for a door system of a door device formed as a drive unit, which does not have a spring and/or an energy accumulator, for example a sliding door, that the partial region comprises a reverse region between an opening travel and a closing travel and/or a reverse region between a closing travel and an opening travel and/or a reverse region between a left-hand travel and a right-hand travel and/or a reverse region between a right-hand travel and a left-hand travel. Such a reverse region is particularly suited for determining wear of the door system or of a subsystem of the door system, for example of a gear unit. According to one embodiment of the present disclosure, such a reverse region can also be understood as a partial region composed of a braking region and a starting region. It is in particular conceivable that the reverse play in such a reverse region is proportional to the wear of the door system or of the subsystem of the door system. It is thereby particularly preferably conceivable that the determined at least one item of measurement information or the determined measurement information relates to a speed of a moving part of the motor and/or of the gear unit, in particular angular speed of a rotor of the motor and/or of a gear wheel of the gear unit and/or a current and/or a control voltage of the motor of the drive unit. On the basis of such measurement information, a particularly advantageous determination of signs of wear is thereby possible.

According to one embodiment of the present disclosure, it is provided that the determined and/or verified status of the door system relates to or comprises a wear status of a subsystem of the door system and/or a wear status of a plurality of subsystems of the door system and/or a wear status of the entire door system. The artificial intelligence system is accordingly in particular provided for determining and/or verifying wear of the door system and/or for determining and/or verifying wear of one or a plurality of subsystems of the door system.

According to one embodiment of the present disclosure, it is possible that statistical and/or stochastic methods are used when determining the at least one item of measurement information or the measurement information. It is conceivable that the at least one item of measurement information comprises an integral value. It is conceivable that the integral value is determined by means of a numeric integration.

According to one embodiment of the present disclosure, it is possible that statistical and/or stochastic methods are used when determining and/or verifying the status of the door system in the status determination step.

According to one embodiment of the present disclosure, it is conceivable that the measurement information is determined in the measuring step in such manner that a plurality of measurement values relating to at least one measurement variable and/or a plurality of measurement values relating to at least one actuation variable are determined during an operating phase of the door system or only during a partial region of an operating phase of the door system. An area integral is formed by means of a numeric integration for the measurement values determined during the operating phase or the partial region of the operating phase. The determined measurement information preferably comprises the area integral determined in this manner. Alternatively or additionally, other statistical and/or numeric methods are also conceivable for determining the measurement information, for example deriving, forming an average value, forming a variance and/or standard deviation.

According to one embodiment of the present disclosure, it is provided that the door system is a partial system of a door device,

in particular wherein the door system is a drive unit of the door device or comprises a drive unit of the door device. Alternatively, it is for example conceivable that the door system comprises or is an electric lock of a door device. Other partial systems of a door device are also considered for the door system. Alternatively, it is conceivable that the door system is a complete door device.

According to one embodiment of the present disclosure, the door device is an entry device, for example for an area or a building. It is preferably conceivable that the door device is an automatic door device. It is conceivable that the door device comprises one or a plurality of the following devices:
a hinged door,
a swing leaf door,
a revolving door,
a security revolving door,
a double entry gate,
a sliding door,
a bifold door,
a tripod turnstile,
a turnstile,
a pivot door.

According to the disclosure, it is advantageously conceivable that by means and/or as a function of the status determined and/or verified in the status determination step a maintenance indication relating to the door system and/or relating to one or a plurality of the subsystems of the door system is output and/or maintenance of the door system and/or of one or of a plurality of the subsystems of the door system is carried out. The maintenance indication is in particular information indicating whether maintenance of the door system must be carried out and/or when maintenance of the door device and/or of the door system must be carried out. The maintenance indication is preferably transmitted to a maintenance device and/or provided to a maintenance technician.

According to one embodiment of the present disclosure, it is conceivable that a plurality of items of measurement information are preferably used to determine and/or verify the status of the door system in the status determination step. The measurement information comprises in particular operating and/or sensor data relating to the door system and/or the door device. According to the disclosure, it is therefore conceivable that, in particular in the status determination step, characteristic wear and/or damage features are advantageously extracted from the operating and/or sensor data by machine learning algorithms with the optional assistance of statistical and/or stochastic methods (for example by means of a correlation between operating parameters and anomalies).

According to one embodiment of the present disclosure, it is provided that the at least one item of measurement information relates to or comprises:
position profiles,
speed profiles,
acceleration profiles,
motor actuation profiles, in particular a pulse width modulation,
current profiles, in particular of a motor and/or overall current,
voltage profiles, in particular of a power supply voltage and/or motor voltage,
temperature profiles, in particular of a temperature of an environment, of a motor, of a power supply and/or of one or of a plurality of electric parts,
vibration profiles, in particular acoustics, preferably a structure-borne sound profile.

According to one embodiment of the present disclosure, it is conceivable that the at least one item of measurement information relates to and/or comprises at least one position profile.

According to one embodiment of the present disclosure, it is conceivable that the at least one item of measurement information relates to or comprises at least one speed profile.

According to one embodiment of the present disclosure, it is conceivable that the at least one item of measurement information relates to or comprises at least one acceleration profile.

According to one embodiment of the present disclosure, it is particularly advantageously possible for a door system formed as a drive unit that the at least one item of measurement information comprises acoustics, in particular structure-borne sound, a speed, position and/or acceleration of a moving part of the motor and/or of the gear unit. In particular, it can thereby be an angular speed, angular position and/or angular acceleration of a rotor of a motor and/or of a gear wheel of the gear unit. Such measurement information is particularly suitable for identifying wear of the door system and/or of the gear unit.

According to one embodiment of the present disclosure, it is conceivable that the at least one item of measurement information relates to or comprises at least one motor actuation profile, in particular a pulse width modulation. For a door system formed as a drive unit, it is for example particularly advantageously possible that the at least one item of measurement information relates to or comprises a pulse width modulation of the motor of the drive unit since it is particularly suitable for determining signs of wear.

According to one embodiment of the present disclosure, it is conceivable that the at least one item of measurement information relates to or comprises at least one current profile, in particular of a motor and/or overall current. For a door system formed as a drive unit, it is for example particularly advantageously possible that the at least one item of measurement information relates to or comprises a motor current of the drive unit. The motor current is particularly suitable for identifying wear of the door system and/or of a subsystem of the door system.

According to one embodiment of the present disclosure, it is conceivable that the at least one item of measurement information relates to or comprises at least one voltage profile, in particular of a power supply voltage and/or motor voltage. For a door system formed as a drive unit, it is for example particularly advantageously possible that the at least one item of measurement information relates to or comprises a control voltage of the motor of the drive unit since it is particularly suitable for determining signs of wear.

According to one embodiment of the present disclosure, it is conceivable that the at least one item of measurement information relates to or comprises at least one temperature profile, in particular of a temperature of an environment, of a motor, of a power supply and/or of one or of a plurality of electric parts.

According to one embodiment of the present disclosure, it is conceivable that the at least one item of measurement information relates to or comprises at least one vibration profile, in particular a structure-borne sound profile.

According to one embodiment of the present disclosure, it is advantageously possible in particular for a door system formed as a drive unit that the measurement information determined in the measuring step relates to or comprises an angular speed profile of a gear unit of the drive unit against the time and/or against a position of a moving part of the motor or of the gear unit, in particular against an angle of a rotor of the motor and/or of a gear wheel of the gear unit. Signs of wear of the drive unit and/or of a subsystem of the drive unit, for example of the gear unit or of the motor, can be determined particularly advantageously by means of such measurement information.

According to one embodiment of the present disclosure, it is advantageously possible in particular for a door system formed as a drive unit that the measurement information determined in the measuring step relates to or comprises an acceleration profile of a moving part of the motor and/or of the gear unit, in particular an angular acceleration profile of a rotor of the motor and/or of a gear wheel of the gear unit of the drive unit against the time and/or against a position of a moving part of the motor or of the gear unit, in particular against an angle of a rotor of the motor or of a gear wheel of the gear unit. Signs of wear of the drive unit and/or of a subsystem of the drive unit, for example of the gear unit or of the motor, can be determined particularly advantageously by means of such measurement information.

According to one embodiment of the present disclosure, it is advantageously possible in particular for a door system formed as a drive unit that the measurement information determined in the measuring step relates to or comprises a motor current of a motor of the drive unit against the time and/or against a position of a moving part of the motor or of the gear unit, in particular against an angle of a rotor of the motor and/or of a gear wheel of the gear unit. A particularly advantageous determination of signs of wear of the drive unit and/or of a subsystem of the drive unit is hereby possible.

According to one embodiment of the present disclosure, it is advantageously possible in particular for a door system formed as a drive unit that the measurement information determined in the measuring step relates to or comprises a pulse width modulation and/or control voltage of a motor of the drive unit against the time and/or against a position of a moving part of the motor or of the gear unit, in particular against an angle of a rotor of the motor and/or of a gear wheel of the gear unit. A particularly advantageous determination of signs of wear of the drive unit and/or of a subsystem of the drive unit is hereby possible.

It is conceivable that parameters and/or variables of the door system and/or of the door device are provided to the model and/or the artificial intelligence system, in particular also parameters and/or variables which relate to the manufacturing state of the door system and/or the door device and are preferably not caused by wear. Alternative or additionally, it is conceivable that the model and/or the artificial intelligence system comprises such parameters and/or variables of the door system and/or of the door device.

According to one embodiment of the present disclosure, such parameters and/or variables of the door system and/or of the door device for example comprise one or a plurality of the following parameters and/or variables:
a weight of the door system and/or of the door device,
dimensions of the door system and/or of the door device, in particular heights and/or widths,
tolerances, in particular manufacturing tolerances, of the door system and/or of the door device,
a setting of the operating parameters of the door system and/or of the door device,
other particularities of the door system and/or of the door device.

According to one preferred embodiment of the present disclosure, the parameters and/or variables, which relate to the manufacturing state of the door system and/or of the door device, comprise or relate to at least one weight of the door system and/or of the door device.

According to one preferred embodiment of the present disclosure, the parameters and/or variables, which relate to the manufacturing state of the door system and/or of the door device, comprise or relate to at least one dimension of the door system and/or of the door device, in particular a height and/or width.

According to one preferred embodiment of the present disclosure, the parameters and/or variables, which relate to the manufacturing state of the door system and/or of the door device, comprise or relate to at least tolerances, in particular manufacturing tolerances, of the door system and/or of the door device.

According to one preferred embodiment of the present disclosure, the parameters and/or variables, which relate to the manufacturing state of the door system and/or of the door device, comprise or relate to a setting of the operating parameters of the door system and/or of the door device.

A further subject matter of the present disclosure is a status determination device for determining and/or verifying a status of a door system,
wherein the status determination device is configured for obtaining at least one determined item of measurement information relating to the door system,
wherein the status determination device is configured for determining and/or verifying the status of the door system by means of an artificial intelligence system and by means of the at least one determined item of measurement information.

The status determination device is preferably a computer-implemented status determination device.

The status determination device preferably comprises means, which are configured for carrying out a method for determining and/or verifying a status of a door system according to one embodiment of the present disclosure. It is conceivable that the status determination device is partially or completely formed as part of the door device, which includes the door system. It is conceivable that the status determination device is partially or completely formed as part of the door system. Alternatively or additionally, it is conceivable that the status determination device is partially or completely formed externally to the door device. For example, it is conceivable that the status determination device is formed by means of a cloud.

It is conceivable that the status determination device is in communicative connection with the door device and/or the door system and/or the measuring device and/or the control device, in particular by means of communication means. It is conceivable that the communication means are formed for wireless and/or wired information and/or signal transmission. It is conceivable that the communication means comprise means for information and/or signal transmission between the status determination device and the door device and/or between the status determination device and the door system and/or between the status determination device and the measuring device and/or between the status determination device and the control device.

According to one embodiment of the present disclosure, it is possible that the status determination device is partially or completely formed by an edge device. The edge device is preferably a device, which provides an entry point into a core network, for example of a company or of a service provider.

It is conceivable that the edge device is installed in direct proximity to the door system and/or the door device and/or that the edge device is formed as part of the door system and/or of the door device.

It is conceivable that the edge device is a module separated from the door system and/or the door device, which is connected to the control device of the door system and/or of the door device via a data connection. Alternatively, it is conceivable that the edge device is a part of the control device such that for example a combination of a microcontroller and an embedded Linux device is formed. It is conceivable that the edge device is an expansion module with machine learning functions and/or data transmission means
for a door device, and/or
for a door system, and/or
for a control device of a door system and/or of a door device.

It is conceivable that the edge device comprises both the status determination device and the control device of the door system and/or of the door device. In this case, it is in particular conceivable that a separate microcontroller door controller is not required, in particular in addition to the edge device.

It is conceivable that the edge device is advantageously an expansion for a door device. The edge device is thereby formed for example as a chip and/or stick, in particular as a special artificial intelligence chip and/or stick, which is formed so as to be connectable to the door device and/or the door system via an interface. The edge device is particularly preferably provided for processing comparatively large quantities of data.

It is conceivable that the edge device and/or the control device is expanded by a status determination device according to one embodiment of the present disclosure and/or is expanded by its functionality. It is thereby possible that an edge device and/or a door controller is expanded by one or a plurality of artificial intelligence hardware devices, in particular special artificial intelligence hardware (or AI hardware), such as for example one or a plurality of chips and/or USB sticks. Such an artificial intelligence hardware device typically has a number of computer cores, preferably at least 16 computer cores, particularly preferably at least 100 computer cores. Preferably, the artificial intelligence hardware device therefore in particular is configured in such manner that it can process a comparatively large quantity of parallel processes at a comparatively very high speed.

It is conceivable that, in particular for configuring the status determination device, an edge device and/or a control device are expanded by one or a plurality of artificial intelligence hardware devices (or AI hardware), such as for example one or a plurality of chips and/or sticks, which are specialized for parallel data processing. Examples of such special artificial intelligence hardware devices are GPUs (graphics processing units) and TPUs (tensor processing unit). In this way, the computing power for artificial intelligence applications can be notably increased.

According to one embodiment of the present disclosure, it is in particular conceivable that the training phase of the artificial intelligence system comprises a learning process. According to one preferred configuration, it is conceivable that the learning process comprises one or a plurality of the following steps:
(i) collecting measurement information, in particular from operating and/or sensor data. It is conceivable that the measurement information is determined at the door system and/or the door device. The measurement information can in particular comprise operating and/or sensor data for one or a plurality of measurement variables and/or actuation variables of the door system.
(ii) processing, storage (in particular intermediate storage) and forwarding of measurement information to a database system and/or a data analysis system. For example, it is conceivable that the database system and/or the data analysis system is part of the status determination device and/or is in communicative connection with the status determination device.
(iii) teaching-in regular and/or correct data. The regular and/or correct data are in particular part of the training data which is used for training the artificial intelligence system. It is conceivable that this data is generated partially or completely by a model-based approach. Alternatively or additionally, it is conceivable that this data is determined at the door system and/or door device and/or that this data is determined at one or a plurality of further door systems, in particular by means of tests in a test environment and/or by means of measurements at installed further door systems and/or door devices in use. In particular, entry systems are often designed in a highly-customized manner and are adjusted to determined applications. However, for training an artificial intelligence system, a broad basis of regular data is typically necessary and advantageous in order to illustrate most characteristics of a product. In this case, it is particularly advantageously possible according to the disclosure to use model-based training data (i.e. in particular simulation data) for training the artificial intelligence system and therefore to achieve a broad database. In this way, time and costs can be saved when developing a broad database of regular data.

The training data, in particular the regular and/or correct data, can for example comprise data for one or a plurality of the following properties of a door system and/or of a door device:
different door weights,
different door dimensions and/or measurements, in particular different widths and/or heights,
setting of the operating parameters,
other particularities.

Therefore, as part of the training data, different door weights, dimensions and/or operating parameters are taken into account and/or advantageously used for the training of the artificial intelligence system.
(iv) teaching-in, in particular targeted teaching-in, of anomalies by means of anomaly data. The anomaly data can also be understood as wear operating data. The anomaly data is in particular part of the training data which is used for training the artificial intelligence system. It is conceivable that this anomaly data is generated partially or completely by a model-based approach. Alternatively or additionally, it is conceivable that the anomaly data is determined at the door system and/or door device and/or that the anomaly data is determined at one or a plurality of further door systems, in particular by means of tests in a test environment and/or by means of measurements at installed further door systems and/or further door devices in use. The model-based approach can also particularly advantageously help here to save time and costs since anomalies can be targetedly output and taught-in. The anomalies in particular comprise signs of wear and/or faults of the door system or of a determined subsystem of the door system or of a plurality of subsystems of the door system. According to one embodiment of the present disclosure, it is in particular possible to configure digital documentation of anomalies in the test field and/or when using a door system such that, prior to the anomalies, available operating and sensor data can be assigned thereto. In this case, the implementation of classified fault trees for selection is particularly advantageous.

It is conceivable to use different types of data to classify regular data and anomaly data. For this purpose, one item or a plurality of items of the following data is in particular conceivable:
position profiles,
speed profiles,
acceleration profiles,
motor actuation profiles, in particular a pulse width modulation,
current profiles, in particular of a motor and/or overall current,
voltage profiles, in particular of a power supply voltage and/or motor voltage,
temperature profiles, in particular of a temperature of an environment, of the motor, of the power supply and/or of one or of a plurality of electric parts,
vibration profiles, preferably noises and/or acoustics, in particular structure-borne sound profiles.

It is conceivable that a door system has one or a plurality of subsystems, which each comprise one or a plurality of moving parts. Each moving part of a door system and/or of a door device, in particular one or a plurality of gear wheels in the gear unit, and/or a motor, has characteristic vibrations and/or has a characteristic acoustic fingerprint. Such characteristic vibrations and/or fingerprints are visible in an overall curve, in particular in a structure-borne sound signal of the door system and/or of the door device and/or of the subsystem and can be assigned to the individual subsystems (or moving parts).

According to one advantageous embodiment of the present disclosure, a separation into speed-dependent and speed-independent effects of the door system and/or of one or a plurality of the subsystems of the door system is conceivable. In this case, the following exemplary embodiments are conceivable, among others:

### FIRST EXAMPLE

Motor vibrations are directly dependent on the speed and can generate their maximum at certain rotational speeds.

### SECOND EXAMPLE

A pulse width modulation and/or a frequency of a pulse width modulation, in particular for actuating a motor, is always constant and independent of the speed.

### THIRD EXAMPLE

A defective ball bearing in a roller is coupled in terms of frequency to the movement speed.

In addition to the first, second and third examples described above, a number of further embodiments are conceivable for different kinds and types of door systems.

According to one embodiment of the present disclosure, it is possible that the speed of the door system and/or of the door device and/or of the structure-borne sound of the door system and/or of the door device are determined by means of sensor devices. The speed of the door system and/or of the door device and/or of the structure-borne sound of the door system and/or of the door device are determined in particular as part of the at least one item of measurement information in the measuring step. It is particularly advantageously conceivable that, from speed-dependent structure-borne sound levels, speed-independent variables are calculated, which can be used for overall classification of a possible defect or wear during a complete travel cycle.

An example of this is described below:

If a ball bearing is defective, a grinding noise is generated. The higher the rotational speed, the higher the generated and measurable (grinding) frequency. By deriving the speed, conclusions can be drawn about the specific defective ball bearing from an overall curve over a complete travel cycle, which includes different speeds. In this case, a speed-independent level of a measurement, in particular of a travel cycle, is visible, which can be monitored. This measurable level behaves in particular proportionally to the wear.

According to one embodiment of the present disclosure, it is possible that the artificial intelligence system performs a feature extraction by means of the anomaly data. In the training phase, the artificial intelligence system is trained in such manner that it can targetedly find taught-in anomalies in the measurement information in the status determination step. Therefore, particularly advantageous pattern detection is possible by means of the artificial intelligence system.

According to one embodiment of the present disclosure, it is possible that the door system and/or the door device can be operated in a plurality of, in particular different, operating states. According to one embodiment of the present disclosure, it is hereby conceivable that a cluster analysis is configured for detecting anomalies by means of the artificial intelligence system. It is conceivable that for one or a plurality of the operating states, in particular for each operating state, a single cluster of training data is generated, preferably both regular data and anomaly data in each case. The artificial intelligence system is preferably trained by means of the training data in such manner that it is configured to detect occurring anomalies in the measurement information for all taught operating states.

According to one embodiment of the present disclosure, it is possible to form a classified and/or delimited fault tree, from which a selection can be carried out for learning purposes in the case of an incident. In this way, particularly advantageous machine learning can be configured for the artificial intelligence system. To this end, digital documentation regarding incidents, such as for example increased wear, defects and/or a parts replacement, is preferably configured such that the operating and sensor data can be used for teaching anomalies before the incident. In this case, a user interface for digital documentation of these incidents is particularly advantageously formed in a database structure or a database-like structure. Together with the operating data or measurement information, anomalies can be used before the incident for targeted training for the purposes of early detection.

Different physical configurations of the system are conceivable.

It is conceivable that the status determination device is formed by means of an edge device as part of the door device and/or of the door system and/or in the environment of the door system and/or of the door device. It is conceivable that the artificial intelligence system of the status determination device automatically learns an initial good status of the door system and/or of the door device. It is preferably conceivable that the artificial intelligence system outputs a warning fully automatically and without a connection to a cloud when previously defined trigger signals are exceeded.

Alternatively, it is conceivable that the edge device communicates with a cloud, in which data relating to a plurality of door systems and/or door devices is merged. Data, in particular regular data and anomaly data, is collected in the cloud regarding different variants and states. The artificial intelligence system is preferably trained by means of such data in the cloud. It is conceivable that the status monitoring step takes place in the cloud such that the status determination device is formed in the cloud. As soon as the measurement information for a door system determined in a measuring step and transmitted to the cloud indicates increased wear or a defect of the door system or one of or a plurality of subsystems of the door system, a corresponding status output from the cloud is possible or an initiation of countermeasures from the cloud is possible.

Alternatively, hybrid models are conceivable.

According to a first exemplary embodiment of such a hybrid model, it is possible that the edge device communicates with a cloud and delivers data or measurement information. The artificial intelligence is preferably continuously trained in the cloud by means of the data and/or by means of data on further door systems and/or further door devices. The taught knowledge or the trained artificial intelligence is transferred at selectable and/or settable times to the edge device which is located around or in the environment of the door system. Similarly, a transfer of taught knowledge or of the trained artificial intelligence, thus in particular of the trained artificial intelligence system, to further edge devices of further door systems is conceivable. In this way, cloud learning and edge computing can advantageously be implemented. The edge device is hereby capable, in particular without requiring a constant cloud connection, to carry out a status determination step and in particular to detect an abnormal state. The edge device in particular has the required computing power for carrying out the status determination for this purpose.

According to a second exemplary embodiment of a hybrid model, it is possible that the edge device communicates with the cloud and transmits training data or measurement information, which is collected for statistical evaluations and/or future machine learning applications. Based on the initial data, an abnormal state of the door system is detected due to pre-programmed trigger signals and a warning is emitted.

According to a third exemplary embodiment of a hybrid model, a combination of the first and second exemplary embodiment is conceivable. In this case, only a part of the knowledge or of the artificial intelligence taught in the cloud is for example transmitted to the edge device, while another part of the knowledge or of the artificial intelligence in the edge device itself, proceeding from an initial good state and pre-programmed trigger signals, is taught.

According to one preferred embodiment of the present disclosure, it is possible that the artificial intelligence system has a machine learning system, a deep learning system, a neuronal network and/or pattern detection.

A further subject matter of the present disclosure is a system for determining and/or verifying a status of a door system, wherein the system comprises a status determination device and the door system,
wherein the status determination device is configured for obtaining at least one determined item of measurement information relating to the door system,
wherein the status determination device is configured for determining and/or verifying the status of the door system by means of an artificial intelligence system and by means of the at least one determined item of measurement information.

The system in particular comprises a status determination device according to one embodiment of the present disclosure and the door system and/or the door device.

The system preferably comprises means, which are configured for carrying out the method for determining and/or verifying a status of a door system according to one embodiment of the present disclosure.

According to one embodiment of the present disclosure, it is conceivable that the system and/or the status determination device has a digital twin for the door system and/or the door device and/or that the system and/or the status determination device can access a digital twin for the door system and/or the door device.

According to one embodiment of the present disclosure, it is provided that the system comprises a measuring device and/or a control device,

wherein the measuring device is configured in such manner that the measuring device determines the at least one item of measurement information by measuring a measurement variable of the door system, wherein the measuring device is configured in particular in such manner that the measuring device provides the at least one item of measurement information to the status determination device and/or
wherein the control device is configured in such manner that the control device determines the at least one item of measurement information by setting and/or determining an actuation variable of the door system, wherein the control device is configured in particular in such manner that the control device provides the at least one item of measurement information to the status determination device.

It is conceivable that the measuring device and/or the control device are partially or completely formed as part of the door device and/or as part of the door system. It is conceivable that the measuring device and/or the control device are formed partially or completely externally to the door system and/or to the door device. The measuring device and/or the control device are thereby at least assigned to the door system.

According to one embodiment of the present disclosure, it is conceivable that the at least one measuring device and/or control device has one, a plurality of or all of the following devices:
a structure-borne sound sensor,
an acoustic sensor,
an electric voltage sensor,
an electric current sensor,
a temperature sensor,
an optical sensor, for example a camera and/or an infrared sensor,
a force sensor,
a strain sensor,
a displacement or distance measuring device.

The measuring device and/or control device is thereby preferably fitted with one or a plurality of sensors or measuring devices suitable for determining the measurement information. The selection of the sensors and/or measuring devices used depends in particular on the measurement variables and/or actuation variables observed by means of the measurement information.

According to one embodiment of the present disclosure, it is conceivable that the at least one measuring device and/or control device has at least one structure-borne sound sensor. In particular, changes in shape over the course of wear, for example abrasion, can be determined by structure-borne sound. Furthermore, the structure-borne sound or its changes in different subsystems can specifically be determined for each subsystem which enables a part-specific determination.

According to one embodiment of the present disclosure, it is conceivable that the at least one measuring device and/or control device has at least one acoustic sensor.

According to one embodiment of the present disclosure, it is conceivable that the at least one measuring device and/or control device has at least one electric voltage sensor.

According to one embodiment of the present disclosure, it is conceivable that the at least one measuring device and/or control device has at least one electric current sensor.

According to one embodiment of the present disclosure, it is conceivable that the at least one measuring device and/or control device has at least one temperature sensor. As a result, increased friction can be determined in mechanical parts and/or increased resistances can be determined in electric parts.

According to one embodiment of the present disclosure, it is conceivable that the at least one measuring device and/or control device has at least one optical sensor, in particular a camera and/or an infrared sensor. The measurement information can thereby represent a comparison or a comparative result between a plurality of image recordings, in particular at least two image recordings, which have been recorded at different times, in particular recorded after a determined time interval. Such measurement information can in particular enable detection of wear on larger parts, in particular on parts, for example on a gear wheel of a gear unit, on a rotor of the motor and/or on a toothed belt, in particular of sliding door systems and/or revolving door systems. Such detection is possible because such parts are generally dimensioned to be larger.

According to one embodiment of the present disclosure, it is conceivable that the at least one measuring device and/or control device has at least one force sensor.

According to one embodiment of the present disclosure, it is conceivable that the at least one measuring device and/or control device has at least one strain sensor.

According to one embodiment of the present disclosure, it is conceivable that the at least one measuring device and/or control device has at least one displacement or distance measuring device.

According to one embodiment of the present disclosure, in particular in the case where the door system comprises a drive unit of the door device, the subsystems of the door system comprise one, a plurality of or all of the following subsystems:
a gear unit,
a tab carriage,
a door,
a motor,
an electronic controller,
a deflection unit, for example a deflection roller and/or a toothed belt,
an energy accumulator, for example a spring and/or a battery,
a power supply,
a force transmission element, for example a toothed belt.

It is preferably conceivable that at least one subsystem of the door system formed as a gear unit is present for a door system formed as a drive unit. In this case, it is particularly advantageously conceivable that the at least one item of measurement information comprises acoustics, in particular structure-borne sound, a speed, position and/or acceleration of a moving part of the motor and/or of the gear unit. In particular, it can thereby be an angular speed, angular position and/or angular acceleration of a rotor of a motor and/or of a gear wheel of the gear unit. Wear of the drive unit and/or of the gear unit can be determined particularly advantageously in this manner.

According to one embodiment of the present disclosure, it is particularly advantageously conceivable that at least one subsystem of the door system formed as a motor is present for a door system formed as a drive unit. In this case, it is particularly advantageously conceivable that the at least one item of measurement information comprises or relates to acoustics, in particular structure-borne sound, a control voltage, a pulse width modulation and/or a motor current. A particularly advantageous determination of wear can hereby be achieved.

According to one embodiment of the present disclosure, it is conceivable that the system is configured in such manner that a prediction can be made by determining and/or verifying the status of the door system in the status determination step as to how long the door system will still be functional without problems. This can for example take place by means of extrapolating historical data for the future.

A particularly advantageous early detection of signs of wear and potential defects can be achieved by means of the present disclosure, which enables improved scheduling of service visits and maintenance work. Thus, a service visit would be possible prior to imminent failure of the door system. Furthermore, a service technician could bring with them the necessary spare parts for the door system or a special subsystem of the door system. It is conceivable that the system is particularly advantageously designed and/or trained such that it can detect by itself which parts of the door system have wear and/or a defect. Therefore, service technicians can avoid making multiple journeys to a door system that is in use.

A further subject matter of the present disclosure is a computer program product, in particular for determining and/or verifying a status of a door system, wherein the computer program product comprises commands, which, when the computer program product is executed by a computer, in particular by a system according to one embodiment of the present disclosure and/or by a status determination device according to one embodiment of the present disclosure, cause the computer to carry out a method according to one embodiment of the present disclosure. The computer can be a single computer device or comprise a plurality of computer devices. The plurality of computer devices can in particular be arranged at different locations, for example partially as part of the door device and/or of the door system and/or in the direct environment of the door system and partially as part or connected to a telecommunications network.

A further subject matter of the present disclosure is a computer-readable storage medium, comprising commands, which, when executed by a computer, in particular by a system according to one embodiment of the present disclosure and/or by a status determination device according to one embodiment of the present disclosure, cause the computer to carry out a method according to one embodiment of the present disclosure.

The features, embodiments and advantages, which have already been described in connection with the method according to the disclosure for determining and/or verifying a status of a door system or in connection with an embodiment of the method according to the disclosure, can thereby be applied to the status determination device according to the disclosure, the system according to the disclosure, the computer program product according to the disclosure and the computer-readable storage medium according to the disclosure. The features, embodiments and advantages, which have already been described in connection with the status determination device according to the disclosure or in connection with one embodiment of the status determination device according to the disclosure, can thereby be applied to the method according to the disclosure, the system according to the disclosure, the computer program product according to the disclosure and the computer-readable storage medium according to the disclosure. The features, embodiments and advantages, which have already been described in connection with the system according to the disclosure or in connection with one embodiment of the system according to the disclosure, can thereby be applied to the method according to the disclosure, the status determination device according to the disclosure, the computer program product according to the disclosure and the computer-readable storage medium according to the disclosure.

### BRIEF DESCRIPTION OF THE DRAWINGS

Further advantages and details of the disclosure will be explained below on the basis of the exemplary embodiments represented in the drawings. They show:

FIG. 1 a schematic representation of a system according to one exemplary embodiment of the present disclosure;

FIG. 2 a schematic representation of a system according to one exemplary embodiment of the present disclosure;

FIG. 3 a schematic representation of a training process of an artificial intelligence system according to one exemplary embodiment of the present disclosure;

FIG. 4 a schematic representation of a method for determining and/or verifying a status of a door system according to one exemplary embodiment of the present disclosure;

FIG. 5 a schematic representation of a generation of a model according to one exemplary embodiment of the present disclosure;

FIG. 6 a schematic representation of a model according to one exemplary embodiment of the present disclosure;

FIG. 7 a schematic representation of a nominal model curve according to one embodiment of the present disclosure obtained by means of a model according to the exemplary embodiment of FIG. 6; and

FIG. 8 a schematic representation of the nominal model curve of FIG. 7 in comparison with a wear-afflicted model curve according to one embodiment of the present disclosure.

### DETAILED DESCRIPTION OF THE DRAWINGS

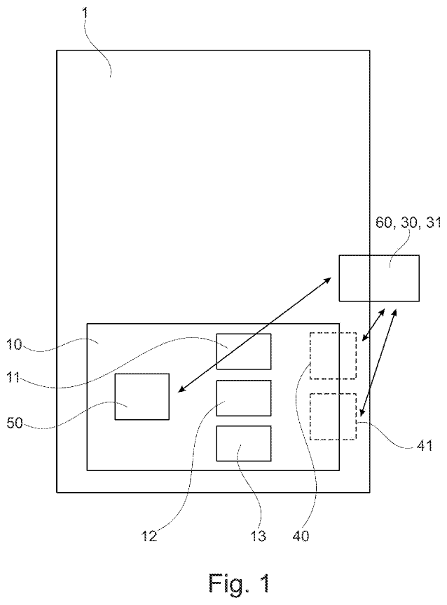

According to one exemplary embodiment of the present disclosure, a system is schematically represented in FIG. 1. The system comprises a door device 1 having at least one door system 10. It is conceivable that the door device 1 has further door systems. The door system 10 is preferably a drive unit of the door device 1. Alternatively, it is for example possible that the door system 10 is an electric lock of the door device 1. The door system 10 typically comprises a plurality of subsystems 11, 12, 13, which can each also be understood as parts or groups of parts, by means of which the door system 10 is formed. Examples of such subsystems 11, 12, 13 of a door system 10 formed as a drive unit are a power supply, an electronic controller, a motor, a gear unit, a tab carriage, an energy accumulator (in particular a spring), etc. The door system 10 has a control device 50 or is connected to a control device 50. The control device 50 can also be understood as a subsystem of the door system 10 according to one embodiment of the present disclosure. The control device 50 is in particular configured for controlling the door system 10 or a function of the door system 10. For example, the control device 50 controls a door system 10 formed as a drive unit by means of a pulse width modulation. The control device 50 outputs an actuation variable for this purpose. It is conceivable that the actuation variable is predefined and set and/or measured or determined by the control device 50. The set and/or determined actuation variables can thereby be understood as determined measurement information 102 of the control device 50. Furthermore, the door system 10 comprises one or a plurality of measuring devices 40, 41, in particular sensors. Alternatively, it is conceivable that the measuring devices 40, 41 are formed partially or completely separately from the door system 10. One or a plurality of measurement variables of the door system 10 can be measured by means of the measuring devices 40, 41. Examples of such measuring devices 40, 41 are structure-borne sound sensors, acoustic sensors, voltage sensors, current sensors, temperature sensors, optical sensors, etc. The measuring devices 40, 41 determine measurement information 100, 101 relating to the door system 10 by measuring measurement variables. The measurement information 100, 101, 102 relates in particular to an operating phase or a partial region of an operating phase of the door system 10 or of the door device 1. The partial region 90 is in particular one or a plurality of connected or separate regions 91, 92, 93, 94 of an operating phase of the door device. The control device 50 and/or the measuring devices 40, 41 are in communicative connection with an edge device 60. It is conceivable that the edge device 60 is connected as a separate device to the door system 10 and/or to the door device 1. Alternatively, it is conceivable that the edge device 60 is arranged only in the environment of the door device 1 and/or of the door system 10. It is alternatively conceivable that the edge device 60 is built in together with the control device 50. The edge device 60 preferably comprises communication means, in particular wireless communication means, for communicating with a local network and/or a telecommunications network. In the represented exemplary embodiment, the edge device 60 comprises a status determination device 30, which has an artificial intelligence system 31. The status determination device 30 can also be formed separately from the edge device 60. For example, it is possible that the status determination device 30 is formed by means of the control device 50.

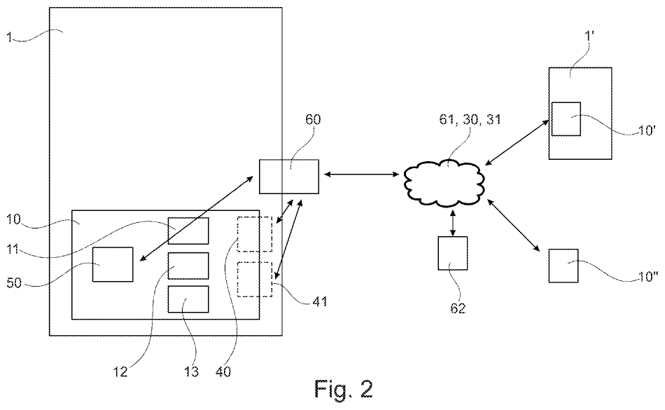

According to one exemplary embodiment of the present disclosure, a system is schematically represented in FIG. 2. Unlike the system represented in FIG. 1, a cloud 61 is shown. The cloud 61 can for example be in communicative connection with the edge device 60 via a telecommunications network and corresponding communication means. In the exemplary embodiment represented in FIG. 2, the status determination device 30 and the artificial intelligence system 31 are configured by means of the cloud 61. The measurement information 100, 101, 102 determined by the measuring devices 40, 41 and/or the control device 50 is transmitted to the cloud 61 via suitable communication means, for example by means of the edge device 60, and provided in such manner to the status determination device 30. The cloud 61 comprises a data carrier 62 and/or is in communicative connection with a data carrier 62. For example, measurement information 100, 101, 102 of the door system 10 and/or

training data 200, 201, 202 can be stored in the data carrier 62. The training data 200, 201, 202 is in particular provided for training the artificial intelligence system 31. The training data 200, 201, 202 preferably comprises model information 200 and/or training measurement information 202 determined and/or output by means of a model 20, which is measured and/or determined at one or a plurality of further door systems 10′, 10″ and/or training measurement information 201, which has been determined at the door system 10. The further door systems 10′, 10″ and/or the assigned further door devices 1′ preferably also have a communication connection with the cloud 61 and/or the data carrier 62 for transmitting such training measurement information 202. It is preferably possible that the further door systems 10′, 10″ are structurally-identical or similar systems to the door system 10.

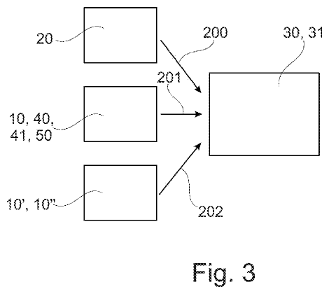

A schematic representation of a training phase of an artificial intelligence system 31 according to one exemplary embodiment of the present disclosure is shown in FIG. 3. In the training phase, the artificial intelligence system 31 is preferably trained by means of training data 200, 201, 202 in such manner that it can detect signs of wear, in particular anomalies and/or defects of the door system 10 and/or of a subsystem 11, 12, 13 in the measurement information 100, 101, 102. Different types of training data 200, 201, 202 can thereby be used to train the artificial intelligence system 31. It is particularly preferably possible that model information 200 generated by means of a model 20 is used to train the artificial intelligence system 31. The model information 200 comprises regular and/or correct data which illustrates a wear-free good state of the door system 10 and/or anomaly data which illustrates a wear state and/or a defect of the door system 10 and/or of a subsystem 11, 12, 13, of the door system 10. The regular and/or correct data can accordingly also be understood as normal operating data which relates to a wear-free state of the door system 10. The anomaly data can accordingly also be understood as wear operating data which relates to a wear state of the door system 10 and/or a wear state of a subsystem 11, 12, 13 of the door system 10. By means of such model information 200, a broad database can be particularly efficiently achieved which enables advantageous training of the artificial intelligence system 31. By means of the model 20, wear operating data or anomaly data can thereby be targetedly generated for determined effects of wear of the door system 10 or of a determined subsystem 11, 12, 13. Therefore, the artificial intelligence system 31 can be targetedly trained for detecting determined effects of wear and for assigning detected patterns to determined subsystems 11, 12, 13. Alternatively or additionally to using model information 200 for training the artificial intelligence system 31, it is possible to use training measurement information 201 which is determined at the door system 10, in particular by means of the control device 50 and/or one or a plurality of measuring devices 40, 41. For example, as training measurement information 201, measurement information 100, 101, 102 can be used, which has been recorded in a normal state of the door system 10 and/or measurement information 100, 101, 102 can be used, which has been recorded in a wear state of the door system, and for which a determined effect of wear has been detected and has been assigned to this measurement information 100, 101, 102. Alternatively or additionally to using model information 200 and/or training measurement information 201 for training the artificial intelligence system 31, it is possible to use training measurement information 202 which has been recorded at one or a plurality of further door systems 10′, 10″, for example by means of measuring devices and/or control devices of the further door systems 10′, 10″. For example, as training measurement information 202, such information can be used, which has been recorded in a normal state of the further door systems 10′, 10″, and/or such information can be used, which has been recorded in a wear state of the further door systems 10′, 10″, and for which a determined effect of wear has been detected and assigned to this training measurement information 202.

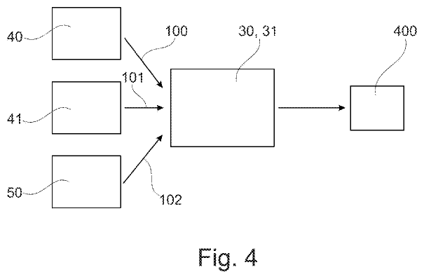

A schematic representation of a method for determining and/or verifying a status of a door system 10 according to one exemplary embodiment of the present disclosure is shown in FIG. 4. Measurement information 100, 101 relating to one or a plurality of measurement variables of the door system 10 is recorded by means of one or a plurality of measuring devices 40, 41. Alternatively or additionally, measurement information 102 relating to one or a plurality of actuation variables of the door system 10 is determined by means of a control device. The measurement information 100, 101, 102 is thereby determined in particular during the operation of the door device 1, which includes the door system 10. The determined measurement information 100, 101, 102 is provided to a status determination device 30. By means of an artificial intelligence system (or an AI functionality) 31, the status determination device 30 analyses the measurement information 100, 101, 102 and thus determines a status of the door system 10. If signs of wear are not determined in the measurement information 100, 101, 102, a wear-free status of the door system 10 is for example determined. If, by means of the artificial intelligence system 31, wear of the door system 10 or of a subsystem 11, 12, 13 of the door system 10 is determined in the measurement information 100, 101, 102, it is conceivable that wear information 400 is output by the status determination device 30. Such wear information 400 can for example indicate an advantageous time frame and/or time for maintenance of the door system 10 determined by means of the artificial intelligence system 31 and/or include information for the subsystem 11, 12, 13 in which wear has been detected (for example also a defect). Such wear information 400 can for example be provided to a service technician and/or be used for planning future maintenance of the door system 10 and/or of the door device 1. In this way, particularly advantageous predictive maintenance is made possible.

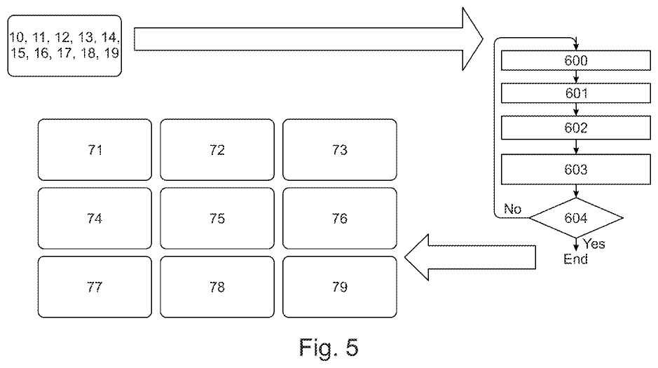

A schematic representation of a method for generating a model 20 according to one exemplary embodiment of the present disclosure is shown in FIG. 5. A real door system 10 is analyzed for this purpose. The properties and parameters of the subsystems 11, 12, 13, 14, 15, 16, 17, 18, 19 are determined in a system influence determination step 600. The relevant system influences are preferably filtered out in a system influence filtering step 601. The door system 10 is segmented or divided into individual subsystems 11, 12, 13, 14, 15, 16, 17, 18, 19 in a system component step 602. The interactions between the individual subsystems 11, 12, 13, 14, 15, 16, 17, 18, 19 (or components) are determined and/or described in an interaction step 603. A verification is carried out in a testing step 604 of the model as to whether the model meets an accuracy criterion, i.e. in particular has a desired accuracy. If the desired accuracy is not reached, all or some of the steps 600, 601, 602, 603, 604 are carried out again, in particular until the desired accuracy is reached. If, in the testing step 604, the desired accuracy is reached, the sequence of steps 600, 601, 602, 603, 604 is terminated. Decomposition and word model formation is carried out. The model 20 preferably has individual model blocks 71, 72, 73, 74, 75, 76, 77, 78, 79 for all relevant subsystems 11, 12, 13, 14, 15, 16, 17, 18, 19. The model blocks 71, 72, 73, 74, 75, 76, 77, 78, 79 can also be understood as simulation partial models.

The following model blocks are conceivable as examples:

The first model block 71 relates to a gear unit.

The second model block 72 relates to a tab carriage.

The third model block 73 relates to a door.

The fourth model block 74 relates to a motor.

The fifth model block 75 relates to an electronic controller.

The sixth model block 76 relates to a deflection unit, in particular a deflection roller and/or a toothed belt.

The seventh model block 77 relates to an energy accumulator, in particular a spring.

The eighth model block 78 relates to a power supply.

The ninth model block 79 relates to a force transmission element, for example a toothed belt.

A number of other possibilities for model blocks are conceivable for different door systems.

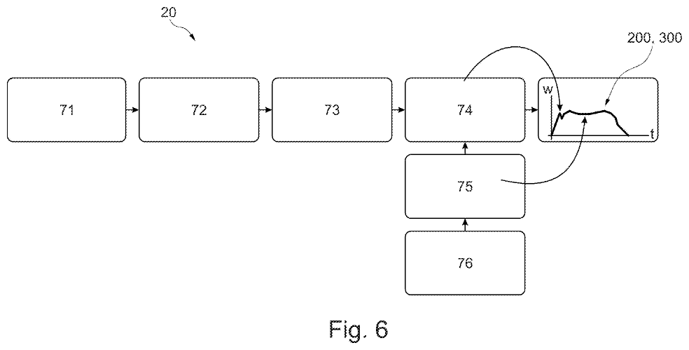

A schematic representation of a model 20 according to one exemplary embodiment of the present disclosure is shown in FIG. 6. The example shows a model 20 for a door system 10 formed as a drive unit. The model 20 comprises a first model block 71 for a power supply, a second model block 72 for an electronic controller, a third model block 73 for a motor, a fourth model block 74 for a gear unit, a fifth model block 75 for a tab carriage and a sixth model block 76 for an energy accumulator (in particular a spring). Model information 200, in particular a model curve 300, is generated for a measurement variable and/or actuation variable measurable at the door system by means of the model 20. In this characteristic model curve 300, individual effects, in particular effects of wear, of the subsystems of the door system 10 observed in the model blocks are identified and assigned to the subsystems. The connections can be identified by means of the model 20 through variations in the properties and parameters of the model blocks. In this case, in particular also a partial region 90 of an operating phase of the door system 10 can be identified, in which determined signs of wear of the door system 10 or of subsystems 11, 12, 13 of the door system 10 are identifiable in measurement information. The partial region 90 can thereby comprise a connected region or two or more separate and spaced apart regions of the operating phase. The model curve 300 is for example an angular speed w of the drive shaft of the gear unit over the time t during an opening travel of the door device 1. In this exemplary embodiment, wear of the gear unit is shown in the front region of the opening travel. Increased wear of the gear unit leads to a decrease in the curve following the acceleration travel. The wear of the gear unit is thereby for example definable as follows: Wear of the gear unit=actual gear unit play−initial gear unit play. Wear of the bearing of the tab carriage for example can be noticeable by a bend of the curve in the constant travel, in particular by a decline in the angular speed with loss of the acceleration components.

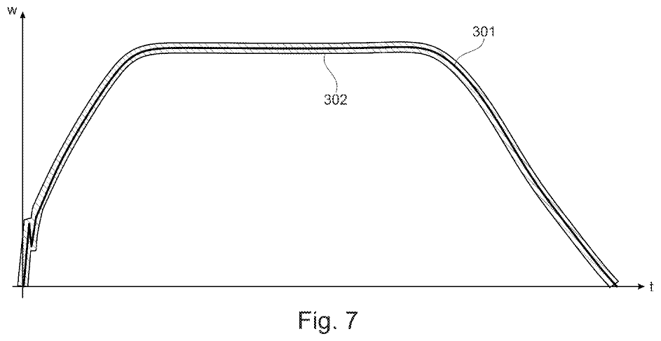

A schematic representation of a nominal model curve 301 obtained by means of a model 20 is shown in FIG. 7. The nominal model curve 301 can thereby also be understood as model information 200. The nominal model curve 301 represents the angular speed w of the drive shaft of a gear unit of a door system 10 as a function of the time t for an opening process of the door device 1, which comprises the door system 10. The gear unit is a subsystem 11, 12, 13 of the door system 10. The nominal model curve 301 is in this case the curve which is obtained without signs of wear of the door system 10, i.e. in particular in a normal state or initial good state of the door system 10. Furthermore, manufacturing and/or tolerance-related deviations 302 of the door system 10 without wear are represented. Such manufacturing- and/or tolerance-related deviations can be taken into account in the model 20 for the different subsystems of the door system 10 and the entire door system 10 by means of model blocks of the model and their properties.

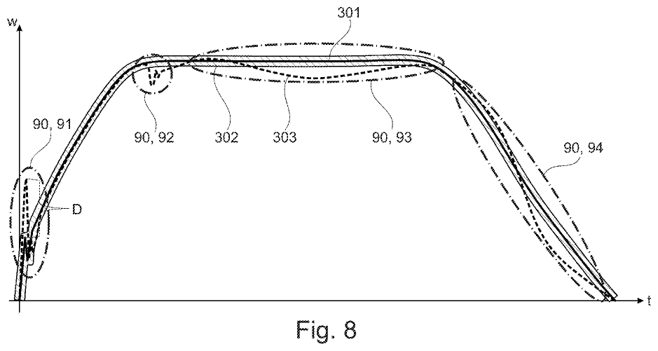

A schematic representation of the nominal model curve 301 of FIG. 7 (without wear) in comparison with a wear-afflicted model curve 303 is shown in FIG. 8. The partial region 90 (or the regions 91, 92, 93, 94 of the partial region 90) of the opening process of the door device 10 is identifiable by means of the model 20 or by means of the model curves 301, 303 generated by the model, in which effects of wear of individual subsystems are shown for a measurement of the angular speed w of the drive shaft of the gear unit. A first, second, third and fourth region 91, 92, 93, 94 of the partial region 90 of the operating phase are in particular represented. The wear of the gear unit can for example be determined and/or quantified via a difference D between a current value and a nominal or initial value. Oscillations are discernible in the first region 91, in particular at the beginning of the opening travel, with increasing gear unit play. The increasing gear unit play is an effect of wear of the gear unit, which is therefore detectable in the first region 91. An increased friction and increased wear of the gear unit leads, in the second region 92, to a decline in the angular speed following the end of the acceleration travel. A decline in the angular speed with increasing friction and increasing wear of the gear unit is also discernible in the third region 93 during a constant travel. Oscillations around the nominal model curve 301 are created in the fourth region 94 with increasing friction. Therefore, a partial region 90, including one or a plurality of separate regions 91, 92, 93, 94, can be determined by means of the model 20, in which signs of wear are determinable by determining measurement information 100, 101, 102 of a door system 20 and preferably being assignable to individual subsystems of the door system 10. FIG. 8 shows an exemplary embodiment of the present disclosure. A number of further exemplary embodiments are conceivable, in which for example measurement variables different to the angular speed w can be used for determining signs of wear and/or determining the partial region 90.

1. A method for determining and/or verifying a status of a door system, wherein the method includes the following steps:
at least one item of measurement information relating to the door system is determined in a measuring step, and
the status of the door system is determined and/or verified by an artificial intelligence system and by the at least one determined item of measurement information in a status determination step.

2. The method according to claim 1, wherein the at least one item of measurement information is determined by measuring a measurement variable of the door system with a measuring device and/or
wherein the at least one item of measurement information is determined by setting and/or determining an actuation variable of the door system with a control device.

3. The method according to claim 1, wherein the artificial intelligence system is trained by training data, at least partially in a training phase before the status determination step.

4. The method according to claim 3, wherein the training data comprises at least one item of model information, determined and/or output by a model.

5. The method according to claim 4, wherein the at least one item of model information relates to at least one measurement variable and/or actuation variable of the door system.

6. The method according to claim 3, wherein the training data comprises training measurement information relating to the door system and/or relating to a door device comprising the door system and/or
wherein the training data comprises training measurement information relating to a further door system and/or a further door device comprising the further door system.

7. The method according to claim 3, wherein the training data includes normal operating data, wherein the normal operating data relates to a wear-free state of the door system
and
wherein the training data includes wear operating data, wherein the wear operating data relates to a wear state of the door system and/or a wear state of a subsystem of the door system.

8. The method according to claim 1,
wherein a partial region of an operating phase of the door system is determined by the artificial intelligence system, in which a sign of wear of a subsystem of the door system and/or a sign of wear of the door system is determinable by determining the at least one item of measurement information, by determining at least one measurement variable and/or actuation variable; and/or
wherein a partial region of an operating phase of the door system is determined by a model, in which a sign of wear of a subsystem of the door system and/or a sign of wear of the door system is determinable by determining the at least one item of measurement information, by determining at least one measurement variable and/or actuation variable.

9. The method according to claim 8, wherein the operating phase of the door system comprises an opening process and/or a closing process of the door system and/or of a door device including the door system, wherein the partial region of the operating phase is only one partial region of the opening process and/or of the closing process.

10. The method according to claim 1, wherein the determined and/or verified status of the door system relates to or comprises a wear status of a subsystem of the door system, and/or a wear status of a plurality of subsystems of the door system, and/or a wear status of the entire door system.

11. The method according to claim 1,
wherein the door system is a partial system of a door device, and
wherein the door system is a drive unit of the door device or comprises a drive unit of the door device.

12. A status determination device for determining and/or verifying a status of a door system,
wherein the status determination device is configured for obtaining at least one determined item of measurement information relating to the door system, and
wherein the status determination device is configured for determining and/or verifying the status of the door system by an artificial intelligence system and by the at least one determined item of measurement information.

13. A system for determining and/or verifying a status of a door system, wherein the system comprises a status determination device and the door system,
wherein the status determination device is configured for obtaining at least one determined item of measurement information relating to the door system, and
wherein the status determination device is configured for determining and/or verifying the status of the door system by an artificial intelligence system and by the at least one determined item of measurement information.

14. The system according to claim 13, wherein the system comprises a measuring device and/or a control device,
wherein the measuring device is configured in such manner that the measuring device determines the at least one item of measurement information by measuring a measurement variable of the door system, wherein the measuring device is configured such that the measuring device provides the at least one item of measurement information to the status determination device and/or
wherein the control device is configured in such manner that the control device determines the at least one item of measurement information by setting and/or determining an actuation variable of the door system, wherein the control device is configured such that the control device provides the at least one item of measurement information to the status determination device.

15. A computer program product, for determining and/or verifying a status of a door system, wherein the computer program product comprises commands, which, when the computer program product is executed by a computer, by a system according to claim 13 and/or by a status determination device for determining and/or verifying a status of a door system configured for obtaining at least one determined item of measurement information relating to the door system, wherein the status determination device is configured for determining and/or verifying the status of the door system by an artificial intelligence system and by the at least one determined item of measurement information, cause the computer to carry out a method for determining and/or verifying a status of a door system, wherein the method includes the following steps: at least one item of measurement information relating to the door system is determined in a measuring step, and the status of the door system is determined and/or verified by an artificial intelligence system and by the at least one determined item of measurement information in a status determination step.
